(19) United States
(12) Patent Application Publication
(10) Pub. No.: US 2025/0123360 A1
(43) Pub. Date: Apr. 17, 2025

(54) RADAR DEVICE AND OBJECT POSITION DETECTION METHOD

(71) Applicant: Mitsubishi Electric Corporation, Tokyo (JP)

(72) Inventor: Yuto NAKAJIMA, Tokyo (JP)

(73) Assignee: Mitsubishi Electric Corporation, Tokyo (JP)

(21) Appl. No.: 18/820,452

(22) Filed: Aug. 30, 2024

(30) Foreign Application Priority Data
Oct. 13, 2023 (JP) 2023-177188

(51) Int. Cl. G01S 7/40; G01S 7/35; G01S 13/32; G01S 13/42; G01S 13/931

(52) U.S. Cl. CPC G01S 7/4021; G01S 7/352; G01S 13/32; G01S 13/42; G01S 13/931

(57) ABSTRACT

This radar device includes a signal processor which calculates a position of an object by analyzing received signals received by a plurality of receiving antennas receiving reflected waves obtained when a transmitted wave radiated from a transmitting antenna is reflected by an object. The signal processor is configured to: calculate a distance of the object from an amplitude peak in a complex spectrum obtained by analyzing the received signals; acquire a complex amplitude at the amplitude peak; correct the complex amplitude by an antenna error correction value stored in advance, and further correct a phase of the corrected complex amplitude on the basis of the position of the object, to calculate an angle-calculation complex amplitude; and calculate an angle for the object, which is an arrival direction of the reflected wave, from the angle-calculation complex amplitude.

### BACKGROUND OF THE INVENTION

### 1. Field of the Invention

The present disclosure relates to a radar device and an object position detection method.

### 2. Description of the Background Art

One example of sensors used for detecting an object such as a front object around an own vehicle in order to prevent collision of an automobile or perform automated driving is a radar device using a high-frequency wave such as a millimeter wave. The radar device receives a reflected wave obtained when a transmitted high-frequency wave is reflected by a detected object, and analyzes the reflected wave, to detect the distance to the object, the relative velocity thereof, or the direction to the object. The distance and the relative velocity can be detected from intensity peaks of the reflected wave, and the direction can be detected from a phase difference between the received waves received by a plurality of receiving antennas. The phase difference is influenced by the relative positions of the plurality of receiving antennas, electromagnetic coupling between the antennas, and in particular, a structure near the receiving antennas (in a case of an automobile, e.g., a bumper if the radar device is placed inside the bumper). Therefore, in a state in which each radar device is mounted, data for device error correction for calibration is acquired for each device, and the data for error correction is stored in each device. In actual usage, correction is performed by the data, to perform angle correction, and then the direction to an object, i.e., the arrival direction of a reflected wave, is detected (see, for example, Patent Document 1)
Patent Document 1: US2017/0045609 A1

In acquiring data for error correction, a reference reflection source is placed at a distance that is not so far from the radar device, and a reflected wave from the reference reflection source is analyzed to obtain the data for error correction. In this case, since the distance between the radar device and the reference reflection source is short, the data for error correction includes phase rotation due to a spherical wave. If an antenna error is corrected using the error correction data including the phase rotation due to the spherical wave, in actual detection, an error is included in an angle calculation value for an object present at a position different from the position of the reference reflection source where the error correction data was acquired.

### SUMMARY OF THE INVENTION

The present disclosure has been made to solve the above problem, and an object of the present disclosure is to provide a radar device capable of obtaining an angle calculation value with higher accuracy while suppressing an error caused by phase rotation due to a spherical wave.

A radar device according to the present disclosure includes: a transmitting antenna; a plurality of receiving antennas which receive, as received signals, reflected waves obtained when a transmitted wave radiated from the transmitting antenna is reflected by an object; and a signal processor which analyzes the received signals received by the receiving antennas, to calculate a position of the object. The signal processor is configured to: calculate a distance of the object from an amplitude peak in a complex spectrum obtained by analyzing the received signals; acquire a complex amplitude at the amplitude peak; correct the acquired complex amplitude by an antenna error correction value stored in advance, and further correct a phase of the corrected complex amplitude on the basis of the position of the object, to calculate an angle-calculation complex amplitude; and calculate an angle for the object, which is an arrival direction of the reflected wave, from the angle-calculation complex amplitude.

With the radar device according to the present disclosure, it becomes possible to provide a radar device capable of obtaining an angle calculation value with higher accuracy while suppressing an error caused by phase rotation due to a spherical wave.

### BRIEF DESCRIPTION OF THE DRAWINGS

FIG. 1 is a block diagram showing the configuration of a radar device according to the first embodiment of the present disclosure;

FIG. 2 is a block diagram showing the internal configuration of a signal processor of the radar device according to the first embodiment;

FIG. 3A, FIG. 3B, and FIG. 3C illustrate phase rotation due to a spherical wave, in the radar device according to the first embodiment;

FIG. 4A and FIG. 4B are graphs showing dependence of an angle calculation value with respect to the distance of an object in comparative examples, in which FIG. 4A shows dependence of an azimuth angle and FIG. 4B shows dependence of an elevation angle;

FIG. 5 is a flowchart showing a procedure of an object position detection method according to the first embodiment;

FIG. 6 conceptually illustrates phase rotation due to a spherical wave;

FIG. 7A and FIG. 7B are graphs showing dependence of an angle calculation value with respect to the distance of an object in a case where only an antenna error is corrected, in which FIG. 7A shows dependence of an azimuth angle and FIG. 7B shows dependence of an elevation angle;

FIG. 8A and FIG. 8B are graphs showing dependence of an angle calculation value with respect to the distance of an object in a case where an antenna error and phase rotation due to a spherical wave are corrected in the radar device according to the first embodiment, in which FIG. 8A shows dependence of an azimuth angle and FIG. 8B shows dependence of an elevation angle; and

FIG. 9 is a block diagram showing an example of a specific configuration of the signal processor of the radar device of the first embodiment.

### DETAILED DESCRIPTION OF THE PREFERRED EMBODIMENTS OF THE INVENTION

### First Embodiment

Examples of radar methods using a high-frequency wave include a frequency modulated continuous wave (FM-CW) method, a fast chirp modulation (FCM) method, and a pulse Doppler method. The technology in the present disclosure is a technology for correcting an error of phase rotation due to a spherical wave and therefore is applicable to any of the methods. Hereinafter, an example using the FCM method will be described.

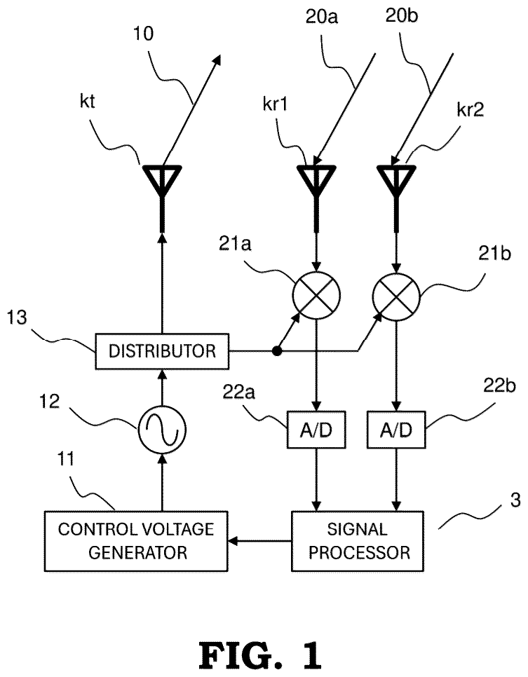

FIG. 1 is a block diagram showing the configuration of a radar device according to the first embodiment of the present disclosure. The radar device includes a transmitting antenna and a receiving antenna. In FIG. 1, for simplification, a radar device including one transmitting antenna kt and two receiving antennas which are a receiving antenna kr1 and a receiving antenna kr2, is shown as an example. In the radar device according to the present disclosure, two or more receiving antennas, i.e., a plurality of receiving antennas, are needed. In a case of using a plurality of transmitting antennas, it is possible to acquire received signals whose number is represented by a product of the number of the transmitting antennas and the number of the receiving antennas. This technology is called a multiple input multiple output (MIMO) technology, and a virtual receiving antenna formed by the MIMO technology is also referred to as simply “receiving antenna”. In the following embodiment, the “receiving antennas” may include not only a “receiving antenna” actually arranged but also a “virtual receiving antenna”.

A signal processor 3 outputs a modulation start instruction to a control voltage generator 11. The control voltage generator 11 generates a voltage waveform having desired control voltage in accordance with the modulation start instruction, and applies the voltage waveform to an oscillator 12. The oscillator 12 outputs a transmitting signal subjected to frequency modulation in accordance with the control voltage. A distributor 13 distributes the outputted transmitting signal to a transmitting antenna kt and mixers 21a and 21b. The transmitting antenna kt radiates a transmitting signal toward an object. Reflected waves reflected by the object are received as received signals by the two receiving antennas kr1 and kr2. By the mixers 21a and 21b individually provided to the respective two receiving antennas kr1 and kr2, the received signals received by the receiving antennas kr1 and kr2 and the transmitting signals distributed by the distributor 13 are mixed respectively, whereby two beat signals are generated. The beat signals obtained by the mixing are converted to digital data by A/D converters 22a and 22b and then are inputted to the signal processor 3.

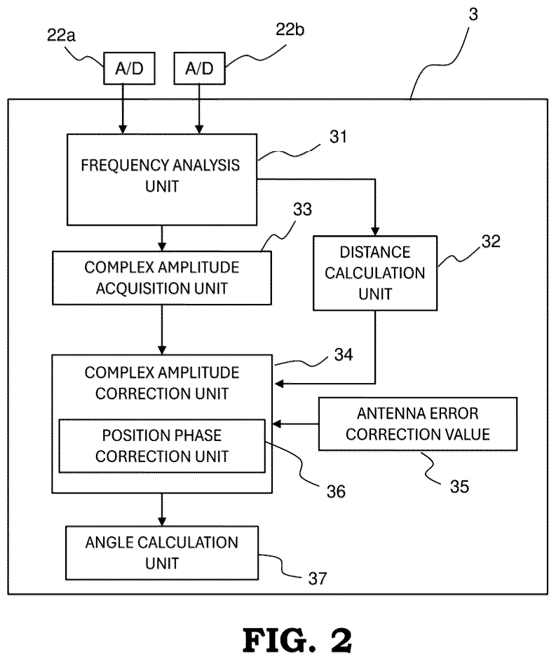

FIG. 2 is a block diagram of the internal configuration of the signal processor 3. The two inputted digital data are subjected to frequency analysis by a frequency analysis unit 31. From a peak of an amplitude (hereinafter, referred to as an amplitude peak) in a complex spectrum which is two frequency analysis results, a distance calculation unit 32 calculates the distance to a reflection point for the received signals, i.e., the distance of the object. Further, a complex amplitude acquisition unit 33 acquires a complex amplitude at the amplitude peak. In a complex amplitude correction unit 34, first, an antenna error based on a device error is corrected on the complex amplitude acquired by the complex amplitude acquisition unit 33, using an antenna error correction value 35 stored in advance. Next, in a position phase correction unit 36 provided in the complex amplitude correction unit 34, a phase of the complex amplitude is further corrected on the basis of the position of the object. Using an angle-calculation complex amplitude which is the complex amplitude corrected as described above, an angle calculation unit 37 calculates the direction to the object which is the arrival direction of the amplitude peak, i.e., the angle to the object. Thus, an angle calculation result which depends on the position of the object and in which an error of phase rotation due to a spherical wave has been removed, is obtained.

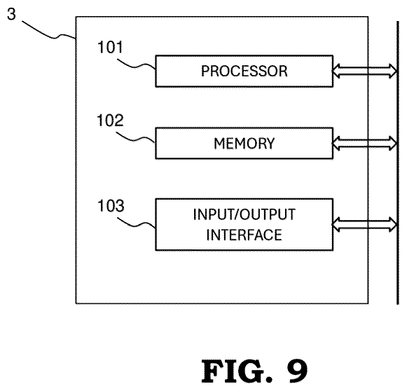

Here, the frequency analysis unit 31, the distance calculation unit 32, the complex amplitude acquisition unit 33, the complex amplitude correction unit 34, the angle calculation unit 37, and the like are incorporated in the signal processor 3. The signal processor 3 includes, for example, as shown in FIG. 9, a processor 101 such as a central processing unit (CPU), a memory 102 which transmits and receives data to and from the processor 101, an input/output interface 103 which allows input and output of signals between the processor 101 and the outside, and the like. As the processor 101, an application specific integrated circuit (ASIC), an integrated circuit (IC), a digital signal processor (DSP), a field programmable gate array (FPGA), various signal processing circuits, and the like may be provided. As the memory 102, a random access memory (RAM) configured to allow data to be read therefrom and written therein by the processor 101, a read only memory (ROM) configured to allow data to be read by the processor 101, and the like are provided. The functions of the frequency analysis unit 31, the distance calculation unit 32, the complex amplitude acquisition unit 33, the complex amplitude correction unit 34, the angle calculation unit 37, and the like, are implemented by the processor 101 executing a program stored in the memory 102, for example. The input/output interface 103 is formed by, for example, an interface for converting a signal inputted from the outside to a signal that can be inputted to the processor 101, an interface for performing transmission and reception of signals between the processor 101 and the control voltage generator 11, an interface for outputting a calculation result from the processor 101 to the outside, or the like.

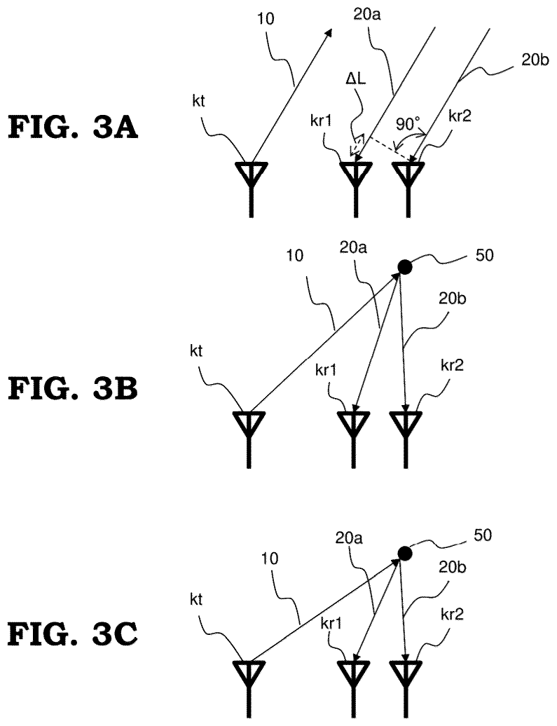

First, phase rotation due to a spherical wave will be described. FIG. 3A to FIG. 3C schematically show cases where a transmitted wave 10 transmitted from the transmitting antenna kt is reflected by an object 50 and then is received by the receiving antenna kr1 and the receiving antenna kr2. FIG. 3A shows a case where the object is at a sufficiently far location so that the reflected waves can be assumed to be plane waves at the positions of the receiving antennas. Under the assumption of plane waves, the direction of the reflected waves (the angle thereof from a base direction) can be obtained by measuring a reflected wave phase difference corresponding to a distance difference ΔL between a reflected wave 20a incident on the receiving antenna kr1 and a reflected wave 20b incident on the receiving antenna kr2.

However, in a case where the distance of the object is short, as shown in FIG. 3B, the reflected wave 20a incident on the receiving antenna kr1 and the reflected wave 20b incident on the receiving antenna kr2 deviate from a plane wave and are different in their directions. This is referred to as phase rotation due to a spherical wave. In calculating the direction of the reflected waves, the direction cannot be accurately calculated unless phase rotation due to a spherical wave is corrected. FIG. 3C shows a case where the distance of the object is even shorter, and the influence of phase rotation due to a spherical wave is greater than in FIG. 3B. Thus, the influence of phase rotation differs depending on the position of the object 50. In the present disclosure, an error of phase rotation due to a spherical wave is corrected on the basis of the position of an object, whereby accurate direction calculation, i.e., accurate angle calculation, is performed.

Meanwhile, in general, in radar devices, as an error for each device, antenna errors (amplitude error and phase error) are included in antennas, due to the internal structure of a radar, magnetic coupling between the antennas, and the like. These errors lead to, in particular, deterioration in angle calculation accuracy, and therefore it is necessary to correct the errors for each device at the time of shipping, for example. For this purpose, at the time of shipping or the like, antenna error correction data is acquired to generate an antenna error correction value such as a correction vector for eliminating a specific angle error or a correction matrix for reducing an error of an angle range where measurement can be performed. Regarding the antenna error correction value, for example, using the object 50 shown in FIG. 3B as a reference reflection source for which the distance and the direction are already known, data is acquired, and the antenna error correction value is generated so as to obtain the known distance and direction from the data.

The antenna error correction value generated as described above includes the aforementioned phase rotation due to a spherical wave, besides the amplitude error and the phase error as device errors. Therefore, in actual operation, if angle calculation is performed using the antenna error correction value including phase rotation due to a spherical wave, correction including phase rotation due to a spherical wave is performed. In a case where an object is present at the same position as the reference reflection source used at the time of acquiring the antenna error correction data, phase rotation due to a spherical wave of a reflected wave from the object is the same as phase rotation due to a spherical wave of a reflected wave from the reference reflection source, and therefore, even if angle calculation is performed using the antenna error correction value including phase rotation due to a spherical wave, an angle calculation result in which device errors and an error of phase rotation due to a spherical wave have been removed is obtained. However, if the position of the object is different, phase rotation due to a spherical wave differs. Therefore, for the object at a position different from the reference reflection source, if angle calculation is performed using the antenna error correction value including phase rotation due to a spherical wave acquired using the reference reflection source, error correction for difference in phase rotation due to a spherical wave cannot be performed, and thus an accurate angle calculation value cannot be obtained.

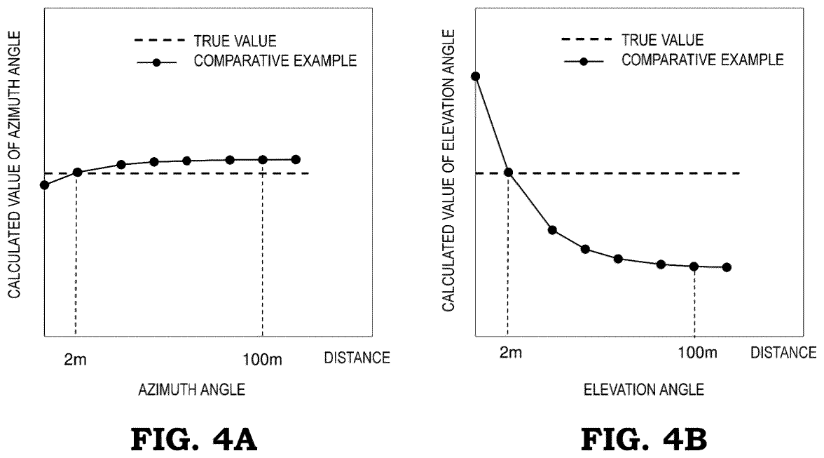

FIG. 4A and FIG. 4B show angle calculation values for objects located at respective distances with an azimuth angle and an elevation angle of 0° in a case where angle calculation is performed using an antenna error correction value including phase rotation due to a spherical wave acquired using a reference reflection source located at a distance of 2 m with an azimuth angle and an elevation angle of 0°. As an angle indicating the direction to the object, an azimuth angle and an elevation angle are calculated. As shown in FIG. 4A (azimuth angle) and FIG. 4B (elevation angle), in both values, angle calculation values (values shown as comparative examples) for the object located at a distance of 2 m which is the same as that of the reference reflection source are true values (the values of the azimuth angle and the elevation angle of the actual direction to the object), but angle calculation values for positions deviating from 2 m are values shifted from true values. This is because phase rotation due to a spherical wave differs depending on the position of the object as described above.

In the first embodiment, an antenna error correction value due to a pure plane wave, excluding information about phase rotation due to a spherical wave from the antenna error correction value generated from data of reflected waves from the reference reflection source, is used as an antenna error correction value for correcting antenna errors, and in position detection for an actual object, angle calculation is performed by adding correction of phase rotation due to a spherical wave corresponding to the position of the object, to correction using the above antenna error correction value, thus obtaining accurate angle data.

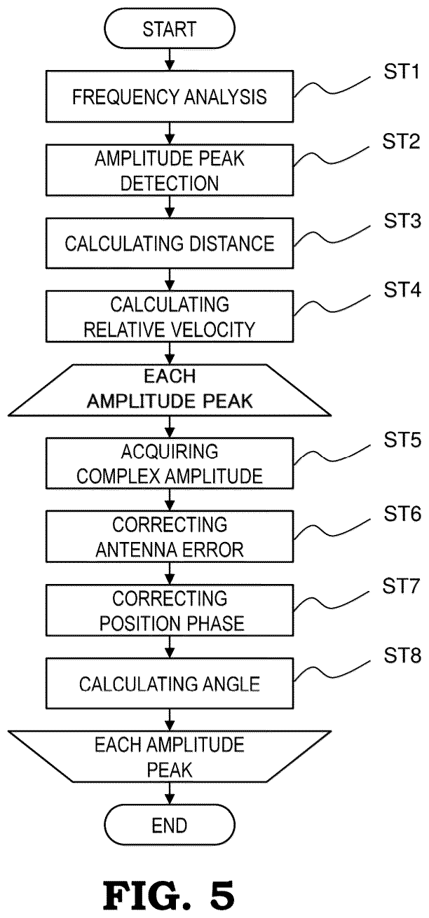

FIG. 5 is a flowchart showing a method for performing position detection for an object, i.e., calculating the distance to the object and angles (azimuth angle and elevation angle) indicating the direction to the object, by correcting error of phase rotation due to a spherical wave, in the radar device according to the first embodiment. A routine from START to END in FIG. 5 is repeatedly performed at every constant cycle or every variable cycle. It is assumed that the radar device has the configuration shown in FIG. 1 and FIG. 2 and performs analysis using the FCM method. Reflected waves obtained when the transmitted wave 10 transmitted from the transmitting antenna kt is reflected by an object are received as the reflected wave 20a and the reflected wave 20b by the receiving antenna kr1 and the receiving antenna kr2, and beat signals obtained by mixing the received signals and the transmitting signals are converted to digital signals by the A/D converters. The converted digital signals are subjected to frequency analysis by the frequency analysis unit 31 in the signal processor 3, to obtain a complex spectrum (step ST1). On the obtained complex spectrum, amplitude peak detection is performed (step ST2). If there are reflected waves from a plurality of objects, a plurality of amplitude peaks are detected. The distance calculation unit 32 calculates the distance of the object for each amplitude peak (step ST3), and calculates the relative velocity of the object (step ST4).

Next, for each amplitude peak, i.e., for each object, an angle is calculated as follows. First, the complex amplitude acquisition unit 33 acquires a complex amplitude from an amplitude peak position of the spectrum (step ST5). The complex amplitude correction unit 34 corrects an antenna error for the complex amplitude acquired by the complex amplitude acquisition unit 33, using the stored antenna error correction value 35 (step ST6). Further, the position phase correction unit 36 in the complex amplitude correction unit 34 corrects the phase of the complex amplitude in accordance with the position of the object (step ST7). The angle calculation unit 37 calculates an angle on the basis of the corrected complex amplitude (step ST8). Processing in steps ST5 to ST8 is performed for each detected peak. Thus, for each object, angle information in which an antenna error and an error based on phase rotation due to a spherical wave have been corrected can be obtained.

The antenna error correction value 35 is prepared on the basis of data acquired using the reference reflection source of which the position, i.e., the distance and the direction (azimuth angle and elevation angle), is already known. Since the position is already known, phase rotation due to a spherical wave corresponding to the position can be obtained. By excluding phase rotation due to the spherical wave from data including phase rotation due to the spherical wave acquired using the reference reflection source, an antenna error correction value for correcting only a pure antenna error can be obtained. The antenna error correction value 35 used in step ST6 is the correction value for correcting only the antenna error as described above.

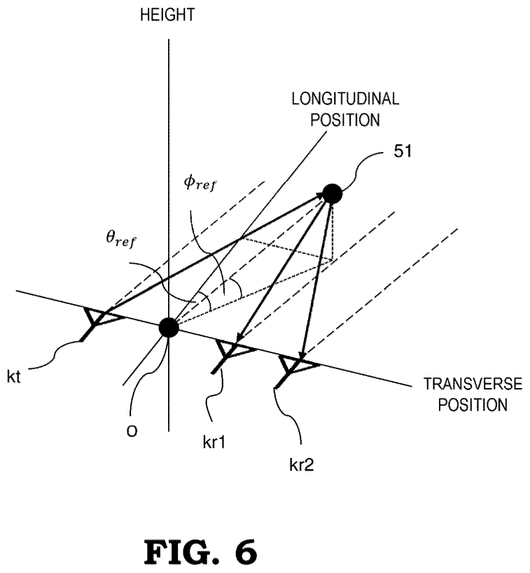

Here, the details of a method for generating the antenna error correction value using the reference reflection source will be described. FIG. 6 schematically illustrates a scene for acquiring data using the reference reflection source. In FIG. 6, lines indicating the longitudinal position, the transverse position, and the height are axes with an origin set at a base point O which is a base position of the radar device. Lines drawn as solid-line arrows show a scene in which a radio wave is radiated from the transmitting antenna kt to a near reference reflection source 51 and reflected waves reflected by the reference reflection source 51 return to the receiving antenna kr1 and the receiving antenna kr2. Lines drawn as broken lines show a scene in which a radio wave is transmitted from the transmitting antenna kt to a sufficiently far location and reflected waves return from an object at the sufficiently far location to the receiving antenna kr1 and the receiving antenna kr2.

Hereinafter, the receiving antenna kr1 and the receiving antenna kr2 are both denoted as receiving antennas kr, and phase rotation from the transmitting antenna to the receiving antenna will be described. First, a single reference reflection source 51 is placed at a predetermined position from the base point O. The position vector of the reference reflection source 51 is denoted by p_{ref} (vector quantity including a transverse position, a longitudinal position, and a height), and the azimuth angle and the elevation angle thereof as seen from the base point O are denoted by θ_{ref} and φ_{ref}, respectively. A radio wave is radiated from the transmitting antenna kt to the reference reflection source 51, and a signal (complex amplitude) received by the receiving antenna kr is denoted by xₖₜₖᵣ. The signal xₖₜₖᵣ includes a complex signal s_{ref} from the reference reflection source, a phase rotation amount ψₖₜₖᵣ through spatial propagation depending on a position, and an antenna error component eₖₜₖᵣ.

xₖ_{ₜ}ₖ_{ᵣ}=eₖ_{ₜ}ₖ_{ᵣ}ψₖ_{ₜ}ₖ_{ᵣ}s_{ref}

A phase to rotate through propagation from the transmitting antenna kt to the reference reflection source 51 is represented by the following expression.

$${ψ}_{t , {k}_{t}} = exp \{ j \frac{2 π}{λ} \sqrt{{\sum }_{k = 1}^{3} {( {p}_{ref , k} - {p}_{t , {k}_{t} , k} )}^{2}} \}$$

Here, λ is the wavelength of the transmitting radio wave, p_{ref,k} is each element of the position vector p_{ref} of the reference reflection source, p_{t,kt,k} is each element of a position vector p_{t,kt} of the transmitting antenna kt, k=1 corresponds to the transverse position, k=2 corresponds to the longitudinal position, and k=3 corresponds to the height. Hereinafter, the same applies to k (=1 to 3) in a suffix.

A phase to rotate through propagation from the reference reflection source 51 to the receiving antenna kr is represented by the following expression.

$${ψ}_{r , {k}_{r}} = exp \{ j \frac{2 π}{λ} \sqrt{{\sum }_{k = 1}^{3} {( {p}_{ref , k} - {p}_{r , {k}_{r} , k} )}^{2}} \}$$

Here, p_{r,kr,k} is each element of a position vector p_{r,kr} of the receiving antenna kr.

Accordingly, a phase to rotate through propagation from when the radio wave is radiated from the transmitting antenna kt to when the radio wave reflected by the reference reflection source 51 returns to the receiving antenna kr, is represented by the following expression.

ψₖ_{ₜ}ₖ_{ᵣ}=ψ_{t,k}_{ₜ}ψ_{r,k}_{ᵣ}

Meanwhile, in a case of the direction indicated by broken lines in FIG. 6, i.e., a case where the reflection point is sufficiently far so that the reflection point is considered to be in the same angle direction (the same azimuth angle θ and the same elevation angle φ) as seen from the antennas, the phase rotation amount is denoted by aₖₜₖᵣ(θ_{ref}, φ_{ref}). In this case, a phase rotation amount that occurs due to a case where the reference reflection source 51 cannot be considered to be at the same angle as seen from the antennas is represented by the following expressions.

$$\begin{matrix}{c}_{{k}_{t} {k}_{r}} = {ψ}_{{k}_{t} {k}_{r}} {a}_{{k}_{t} {k}_{r}}^{*} ( {θ}_{ref} , {ϕ}_{r e f} ) \\ {a}_{{k}_{t} {k}_{r}} ( {θ}_{ref} , {ϕ}_{r e f} ) = {a}_{t , {k}_{t}} ( {θ}_{ref} , {ϕ}_{ref} ) {a}_{r , {k}_{r}} ( {θ}_{ref} , {ϕ}_{r e f} ) \\ {a}_{t , {k}_{t}} ( {θ}_{ref} , {ϕ}_{r e f} ) = exp ( j \frac{2 π}{λ} {p}_{t , {k}_{t}} \cdot p ( {θ}_{ref} , {ϕ}_{r e f} ) ) \\ {a}_{r , {k}_{r}} ( {θ}_{ref} , {ϕ}_{r e f} ) = exp ( j \frac{2 π}{λ} {p}_{r , {k}_{r}} \cdot p ( {θ}_{ref} , {ϕ}_{r e f} ) ) \\ p ( {θ}_{r e f} , {ϕ}_{r e f} ) = [ cos {ϕ}_{r e f} sin {θ}_{r e f} , cos {ϕ}_{r e f} cos {θ}_{r e f} , sin {ϕ}_{r e f} ]\end{matrix}$$

Here, * is complex conjugate, and p(θ_{ref}, φ_{ref}) is a direction vector.

Thus, the complex amplitude (antenna error component) depending on only angles is represented by the following expression.

yₖ_{ₜ}ₖ_{ᵣ}=xₖ_{ₜ}ₖ_{ᵣ}cₖ_{ₜ}ₖ_{ᵣ}=eₖ_{ₜ}ₖ_{ᵣ}aₖ_{ₜ}ₖ_{ᵣ}(θ_{ref},ϕ_{ref})s_{ref}

Using yₖₜₖᵣ as antenna error correction data, an antenna error correction value is generated. The antenna error correction value is a correction value for only an antenna error as a device error, excluding phase rotation due to a spherical wave.

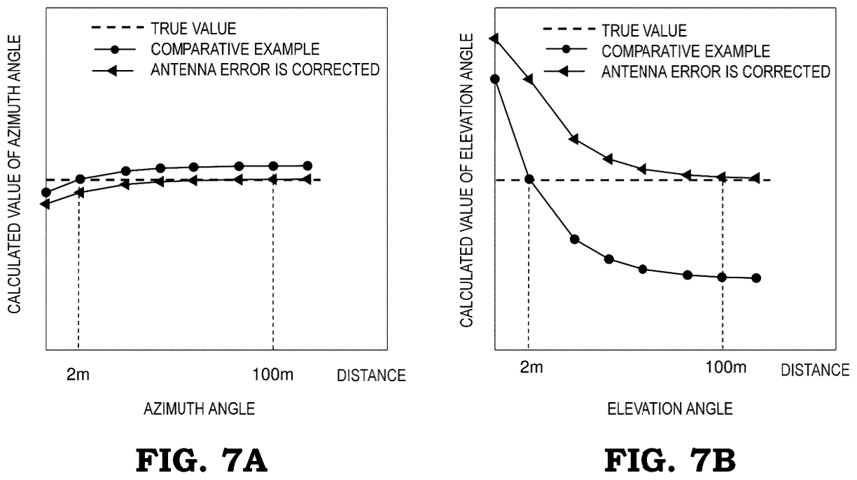

FIG. 7A and FIG. 7B show examples of angle calculation values calculated by correcting an antenna error by an antenna error correction value generated using, as antenna error correction data, yₖₜₖᵣ calculated on the basis of data acquired from the reference reflection source at a distance of 2 m. In FIG. 7A and FIG. 7B, the angle calculation values calculated using the antenna error correction value including phase rotation due to a spherical wave shown in FIG. 4A and FIG. 4B are also shown as comparative examples. As shown in FIG. 7A and FIG. 7B, it is found that, in both of the azimuth angle and the elevation angle, accuracy of angles for a far object is improved through correction of the antenna error.

When angle calculation is performed using the correction value for only an antenna error as a device error, excluding phase rotation due to a spherical wave, accuracy of angle calculation values for a far object is improved, but accuracy of angles for an object at a short distance close to the distance of the reference reflection source is deteriorated. This is because phase rotation due to a spherical wave has an influence for an object at a short distance. Hereinafter, a method for obtaining angle calculation values having high accuracy irrespective of the object position while considering the influence of phase rotation due to a spherical wave, will be described.

Since the influence of phase rotation due to a spherical wave differs depending on the position of an object, it is necessary to correct phase rotation due to a spherical wave on the basis of the position of the object. Hereinafter, the number of the transmitting antennas is denoted by Kₜ, and the number of the receiving antennas is denoted by Kᵣ. In an actual radar device, Kₜ and Kᵣ are not necessarily the numbers of actual antennas physically placed, but transmitting antennas and receiving antennas for which the number of virtual antennas Kₜ×Kᵣ is not less than 2, may be used. The distance from the base point O of the radar device to the object is denoted by r_{tgt}, the position vector is denoted by p_{tgt}, the azimuth angle is denoted by θ_{tgt}, and the elevation angle is denoted by φ_{tgt}. A complex amplitude vector for all the antennas in a case where an antenna error has been excluded through correction of the antenna error, is denoted by x. Under the assumption that a noise component is not included, the complex amplitude vector x is represented as shown by the following expressions.

$$\begin{matrix}x = C ( {p}_{tgt} ) a ( {θ}_{tgt} , {ϕ}_{tgt} ) {s}_{tgt} \\ a ( {θ}_{tgt} , {ϕ}_{tgt} ) = {a}_{t} ( {θ}_{tgt} , {ϕ}_{tgt} ) ⊗ {a}_{r} ( {θ}_{tgt} , {ϕ}_{tgt} ) \\ {a}_{t} ( {θ}_{tgt} , {ϕ}_{tgt} ) = {[ {a}_{t , 1} ( {θ}_{tgt} , {ϕ}_{tgt} ) , … , {a}_{t , {K}_{t}} ( {θ}_{tgt} , {ϕ}_{tgt} ) ]}^{T} \\ {a}_{r} ( {θ}_{tgt} , {ϕ}_{tgt} ) = {[ {a}_{r , 1} ( {θ}_{tgt} , {ϕ}_{tgt} ) , … , {a}_{r , {K}_{r}} ( {θ}_{tgt} , {ϕ}_{tgt} ) ]}^{T} \\ {\begin{matrix}⊗ : Kronecker product , & ( \cdot \end{matrix} )}^{T} : transpose\end{matrix}$$

Here, a(θ_{tgt}, φ_{tgt}) is a vector indicating a phase rotation amount in a case where the object can be considered to be sufficiently far from the antennas, and C(p_{tgt}) is a diagonal matrix indicating a phase rotation amount based on a position, corresponding to deficiency with respect to only a(θ_{tgt}, θ_{tgt}). That is, a phase rotation amount that occurs through a propagation path is represented by C(p_{tgt}) a(θ_{tgt}, φ_{tgt}). Note that s_{tgt} is a reflection complex amplitude for the object.

The above C(p_{tgt}) is a component that provides an error in angle calculation, and therefore needs to be corrected. A correction matrix is denoted by G and is calculated as shown by the following expression.

G=diag{ΨₜΨᵣa*(θₛₑₜ,ϕₛₑₜ)}

Here, * is complex conjugate, and diag(·) is an operator for generating a diagonal matrix having elements of a vector as diagonal components.

Here, θₛₑₜ and φₛₑₜ are set values (referred to as correction-calculation angles) for the azimuth angle and the elevation angle, and it is preferable that they are set at such angles that will minimize angle calculation errors. By setting them at values as close to true values of the angles for the target object, i.e., θ_{tgt} and φ_{tgt}, as possible, accurate angle calculation values are obtained. Calculation for position detection for an object, i.e., the routine from START to END in FIG. 5, is repeatedly performed in time series at every constant cycle or every variable cycle. Accordingly, for θₛₑₜ and φₛₑₜ, angles (θ_{tgt}, φ_{tgt}) in an angle calculation result for the object at or before the last cycle, or angles estimated from the result and information about position change of the object, may be used as set values. In a case such as an initial cycle of position detection, i.e., a case where there is no angle calculation result of the last cycle as initial values, angles of a base direction of radiation of a transmitted wave radiated from the transmitting antenna (a direction in which the directionality of the transmitting antenna is maximized) may be used as the set values. For example, for an automobile traveling frontward, it is considered that a measurement target object is approximately in a frontward direction, i.e., the azimuth angle and the elevation angle thereof are close to 0° from the base point O, and therefore θₛₑₜ and φₛₑₜ may be both set at 0. As described above, in a case where an approximate direction to the object is known, angles corresponding to the approximate direction are set as θₛₑₜ and φₛₑₜ.

In addition, Ψₜ and Ψᵣ are diagonal matrices representing phase rotation amounts that occur between the transmitting antenna and a set position and between the receiving antenna and the set position, respectively, and are represented by the following expressions.

$$\begin{matrix}{Ψ}_{t} = diag \{ {ψ}_{t} \} \\ {Ψ}_{r} = diag \{ {ψ}_{r} \} \\ {ψ}_{t} = [ {ψ}_{t , 1} , {ψ}_{t , 2} , … , {ψ}_{t , {K}_{t}} ] \\ {ψ}_{r} = [ {ψ}_{r , 1} , {ψ}_{r , 2} , … , {ψ}_{r , {K}_{r}} ] \\ {ψ}_{t , {k}_{t}} = exp \{ j \frac{2 π}{λ} \sqrt{{\sum }_{k = 1}^{3} {( {p}_{set , k} - {p}_{t , {k}_{t} , k} )}^{2}} \} \\ {ψ}_{r , {k}_{r}} = exp \{ j \frac{2 π}{λ} \sqrt{{\sum }_{k = 1}^{3} {( {p}_{s e t , k} - {p}_{r , {k}_{r} , k} )}^{2}} \} \\ {p}_{s e t} = {r}_{est} p ( {θ}_{set} , {ϕ}_{s e t} )\end{matrix}$$

Here, p_{set,k} is each element (a transverse position, a longitudinal position, and a height) of a position vector pₛₑₜ.

The position vector pₛₑₜ is calculated from θₛₑₜ, φₛₑₜ, and a distance calculation value rest calculated from the amplitude peak in step ST3. The above set position is, here, a position in the direction of the correction-calculation angle and at the distance calculated from the amplitude peak.

As shown by the following expression, the complex amplitude vector x is multiplied by the complex conjugate transpose of the matrix G, to obtain a complex amplitude vector y after position phase correction.

y=G^{H}x

Here, (·)^{H} is complex conjugate transpose.

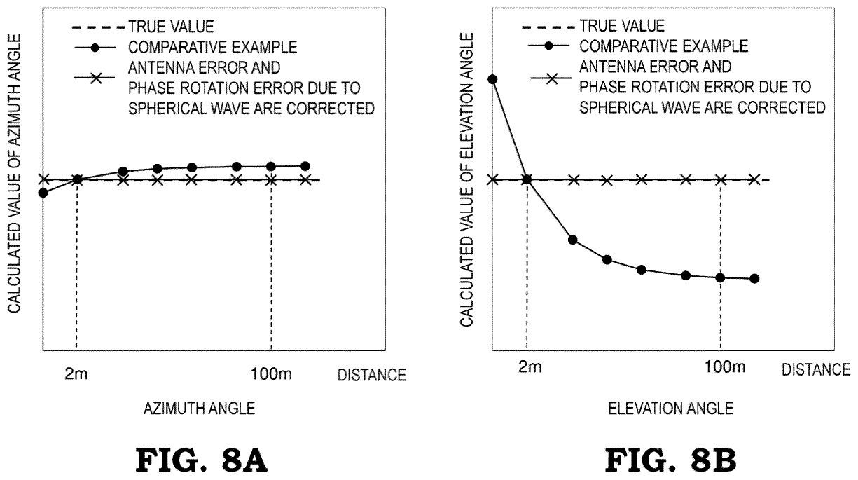

Examples of results of angle calculation using the complex amplitude vector y after phase correction (referred to as an angle-calculation complex amplitude) are shown as “ANTENNA ERROR AND PHASE ROTATION ERROR DUE TO SPHERICAL WAVE ARE CORRECTED” in FIG. 8A (azimuth angle) and FIG. 8B (elevation angle). In FIG. 8A and FIG. 8B, the angle calculation values calculated using the antenna error correction value including phase rotation due to a spherical wave shown in FIG. 4A and FIG. 4B are also shown as comparative examples. As shown in FIG. 8A and FIG. 8B, by performing angle calculation using the angle-calculation complex amplitude y which is the complex amplitude vector after position phase correction, it is possible to perform angle calculation in which the influence of phase rotation due to a spherical wave has been removed, and thus angles close to true values, i.e., the direction of the object, can be detected.

Although the present disclosure is described above in terms of an exemplary embodiment, it should be understood that the various features, aspects and functionality described in the embodiment are not limited in their applicability to the particular embodiment with which they are described, but instead can be applied, alone or in various combinations to the embodiment. It is therefore understood that numerous modifications which have not been exemplified can be devised without departing from the scope of the present disclosure. For example, at least one of the constituent components may be modified, added, or eliminated.

### DESCRIPTION OF THE REFERENCE CHARACTERS

3 signal processor
31 frequency analysis unit
32 distance calculation unit
33 complex amplitude acquisition unit
34 complex amplitude correction unit
35 antenna error correction value
36 position phase correction unit
37 angle calculation unit
10 transmitted wave
20a, 20b reflected wave
51 reference reflection source
kt transmitting antenna
kr, kr1, kr2 receiving antenna

What is claimed is:

1. A radar device comprising:
a transmitting antenna;
a plurality of receiving antennas which receive, as received signals, reflected waves obtained when a transmitted wave radiated from the transmitting antenna is reflected by an object; and
a signal processor which analyzes the received signals received by the receiving antennas, to calculate a position of the object,
wherein the signal processor comprises:
at least one processor; and
at least one memory including computer program code, where the at least one memory and the computer program code are configured, with the at least one processor, to cause the signal processor to at least; and
the signal processor is configured to
calculate a distance of the object from an amplitude peak in a complex spectrum obtained by analyzing the received signals;
acquire a complex amplitude at the amplitude peak;
correct the acquired complex amplitude by an antenna error correction value stored in advance, and further correct a phase of the corrected complex amplitude on the basis of the position of the object, to calculate an angle-calculation complex amplitude; and
calculate an angle for the object, which is an arrival direction of the reflected wave, from the angle-calculation complex amplitude.

2. The radar device according to claim 1, wherein
the antenna error correction value is a correction value generated from data of reflected waves from a reference reflection source placed at a known position.

3. The radar device according to claim 2, wherein
the antenna error correction value is obtained by
correcting a complex amplitude at an amplitude peak in a complex spectrum obtained by analyzing received signals of the reflected waves from the reference reflection source, using a phase rotation amount that occurs in a case where the reference reflection source is considered to be present at the same angle as seen from the transmitting antenna and the receiving antennas, and
performing calculation using the corrected complex amplitude.

4. The radar device according to claim 3, wherein
the angle-calculation complex amplitude is calculated using the distance of the object and a correction-calculation angle.

5. The radar device according to claim 4, wherein
the signal processor repeatedly performs calculation for calculating the position of the object, at every constant cycle or every variable cycle, and the correction-calculation angle is set on the basis of the angle for the object obtained through calculation at a last cycle or a cycle before the last cycle.

6. The radar device according to claim 4, wherein
the correction-calculation angle is set at an angle of a base direction of radiation from the transmitting antenna with respect to a base point of the radar device.

7. The radar device according to claim 1, wherein
the angle-calculation complex amplitude is calculated using the distance of the object and a correction-calculation angle.

8. The radar device according to claim 7, wherein
the signal processor repeatedly performs calculation for calculating the position of the object, at every constant cycle or every variable cycle, and the correction-calculation angle is set on the basis of the angle for the object obtained through calculation at a last cycle or a cycle before the last cycle.

9. The radar device according to claim 7, wherein
the correction-calculation angle is set at an angle of a base direction of radiation from the transmitting antenna with respect to a base point of the radar device.

10. An object position detection method in a radar device including a transmitting antenna, and a plurality of receiving antennas which receive, as received signals, reflected waves obtained when a transmitted wave radiated from the transmitting antenna is reflected by an object, the radar device being configured to analyze the received signals received by the receiving antennas, to calculate a position of the object, the method comprising the steps of:
calculating a distance of the object from an amplitude peak in a complex spectrum obtained by analyzing the received signals;
acquiring a complex amplitude at the amplitude peak;
correcting the acquired complex amplitude by an antenna error correction value stored in advance, and correcting a phase of the corrected complex amplitude on the basis of the position of the object, to calculate an angle-calculation complex amplitude; and
calculating an angle for the object, which is an arrival direction of the reflected wave, from the calculated angle-calculation complex amplitude.

11. The object position detection method according to claim 10, wherein
the antenna error correction value is a correction value generated from data of reflected waves from a reference reflection source placed at a known position.

12. The object position detection method according to claim 11, wherein
the antenna error correction value is obtained by
correcting a complex amplitude at an amplitude peak in a complex spectrum obtained by analyzing received signals of the reflected waves from the reference reflection source, using a phase rotation amount that occurs in a case where the reference reflection source is considered to be present at the same angle as seen from the transmitting antenna and the receiving antennas, and
performing calculation using the corrected complex amplitude.

13. The object position detection method according to claim 12, wherein
the angle-calculation complex amplitude is calculated using the distance of the object and a correction-calculation angle.

14. The object position detection method according to claim 13, wherein
calculation for calculating the position of the object is repeatedly performed at every constant cycle or every variable cycle, and the correction-calculation angle is set on the basis of the angle for the object obtained through calculation at a last cycle or a cycle before the last cycle.

15. The object position detection method according to claim 13, wherein
the correction-calculation angle is set at an angle of a base direction of radiation of the transmitted wave radiated from the transmitting antenna.

16. The object position detection method according to claim 10, wherein
the angle-calculation complex amplitude is calculated using the distance of the object and a correction-calculation angle.

17. The object position detection method according to claim 16, wherein
calculation for calculating the position of the object is repeatedly performed at every constant cycle or every variable cycle, and the correction-calculation angle is set on the basis of the angle for the object obtained through calculation at a last cycle or a cycle before the last cycle.

18. The object position detection method according to claim 16, wherein
the correction-calculation angle is set at an angle of a base direction of radiation of the transmitted wave radiated from the transmitting antenna.
